(19) United States
(12) Patent Application Publication
(10) Pub. No.: US 2024/0066718 A1
(43) Pub. Date: Feb. 29, 2024

(54) GRIPPING MECHANISM AND END EFFECTOR

(71) Applicant: Panasonic Intellectual Property Management Co., Ltd., Osaka (JP)

(72) Inventors: Takuma YABUTA, Kanagawa (JP); Kazunori KOUNO, Osaka (JP); Yoshinari MATSUYAMA, Osaka (JP)

(21) Appl. No.: 18/383,560

(22) Filed: Oct. 25, 2023

Related U.S. Application Data
(63) Continuation of application No. PCT/JP2022/010327, filed on Mar. 9, 2022.

(30) Foreign Application Priority Data
Apr. 28, 2021 (JP) 2021-076368

(51) Int. Cl. B25J 15/00

(52) U.S. Cl. CPC B25J 15/0028

(57) ABSTRACT

A gripping mechanism includes a pair of gripping parts including a first gripping part and a second gripping part facing each other. Each of the first gripping part and the second gripping part includes a first end, a second end opposite to the first end, a projection provided at the first end, and a rotation shaft provided at the second end. The projection is rotatable about the rotation shaft. The first gripping part and the second gripping part face each other in a direction intersecting a direction in which the rotation shafts extend.

### BACKGROUND

### 1. Technical Field

The present disclosure relates to a gripping mechanism and an end effector.

### 2. Description of the Related Art

Patent Literature (PTL) 1 discloses a robot hand. The robot hand includes a base portion, a gripping part that grips a gripping target object with a first gripping part and a second gripping part, and a conformable portion. When the gripping target object is gripped, the conformable portion allows rotation of the first gripping part and the second gripping part about an axis in an extending direction from the base portion and allows rotation of the first gripping part and the second gripping part in an opening and closing direction such that gripping surfaces of the first gripping part and the second gripping part follow a shape of the gripping target object. As a result, it is possible to cause the gripping surface of the gripping part to favorably follow the shape of the gripping target object.
PTL 1 is Unexamined Japanese Patent Publication No. 2012-066368.

### SUMMARY

The present disclosure provides a gripping mechanism and an end effector capable of stably gripping a gripping target object.

A gripping mechanism according to the present disclosure includes a pair of gripping parts including a first gripping part and a second gripping part facing each other. Each of the first gripping part and the second gripping part includes a first end, a second end opposite to the first end, a projection provided at the first end, and a rotation shaft provided at the second end. The projection is rotatable about the rotation shaft. The first gripping part and the second gripping part face each other in a direction intersecting a direction in which the rotation shafts extend.

According to the present disclosure, it is possible to provide the gripping mechanism and the end effector capable of stably gripping the gripping target object.

### BRIEF DESCRIPTION OF THE DRAWINGS

FIG. 1 is a conceptual diagram illustrating a robot arm including an end effector.

FIG. 2 is a perspective view of the end effector.

FIG. 3 is a top view illustrating the end effector.

FIG. 4 is a side view illustrating the end effector.

FIG. 5 is a perspective view illustrating a first gripping part connected to a connection member.

FIG. 6 is an exploded perspective view of the connection member and the first gripping part.

FIG. 7 is a perspective view illustrating the first gripping part connected to the connection member.

FIG. 8 is a conceptual diagram illustrating a first state when a gripping mechanism grips the gripping target object.

FIG. 9 is a conceptual diagram illustrating a second state when the gripping mechanism grips the gripping target object.

FIG. 10 is a conceptual diagram illustrating a third state when the gripping mechanism grips the gripping target object.

FIG. 11 is a conceptual diagram illustrating a fourth state when the gripping mechanism grips the gripping target object.

FIG. 12 is a diagram illustrating a gripping example of the gripping target object by the gripping mechanism.

FIG. 13 is a diagram illustrating a gripping example of the gripping target object by the gripping mechanism.

FIG. 14 is a diagram illustrating a gripping example of the gripping target object by the gripping mechanism.

FIG. 15 is a block diagram illustrating a hardware configuration example of a control device.

### DETAILED DESCRIPTION

(Background to the Present Disclosure)

In general, an end effector such as a robot hand can grip a gripping target object by being controlled by a control device provided on a proximal end side. Here, examples of the gripping target object include tableware. Many tableware have an inclination on a side surface thereof. In addition, an inclination angle of the side surface varies depending on the gripping target object. In addition to tableware, it has been difficult for the end effector to stably grip gripping target objects having inclinations of various angles.

In the robot hand described in PTL 1, a conformable portion is made of an elastic member. In addition, the conformable portion allows rotation of gripping pieces about an axis in an extending direction from the base portion and rotation of the gripping pieces in an opening and closing direction. Thus, when a cup or the like is sandwiched between two gripping pieces, a gripping surface of the gripping piece follows an outer peripheral shape of the cup.

However, it has been still difficult for the robot hand to grip the gripping target object having an inclination such as a flat dish. When a force with which the gripping pieces sandwiches the gripping target object is weak, it is difficult to stably grip the gripping target object, and there is a possibility that the gripping target object slides down. On the other hand, when the force with which the gripping pieces sandwiches the gripping target object is strong, the gripping target object slides out from the gripping pieces along the inclination. Similarly, it is difficult to stably grip the gripping target object, and there is a possibility that the gripping fails. Further, since the inclination of the gripping target object is not necessarily a linear inclination, the gripping pieces may not generate a sufficient frictional force for stably gripping the gripping target object.

Therefore, in the following exemplary embodiment, a gripping mechanism and an end effector capable of stably gripping a gripping target object mainly having an inclination will be described in detail.

Hereinafter, an exemplary embodiment (hereinafter, referred to as “the present exemplary embodiment”) in which the gripping mechanism and the end effector according to the present disclosure are specifically disclosed will be described in detail with reference to the drawings as appropriate. It is noted that a more detailed description than need may be omitted. For example, the detailed descriptions of already well-known matters and overlap descriptions of substantially the same configurations may be omitted. This is to avoid the following description from being unnecessarily redundant and thus to help those skilled in the art to easily understand the description. Note that, the accompanying drawings and the description below are provided for those skilled in the art to fully understand the present disclosure, and are not intended to limit the subject matter described in the scope of claims.

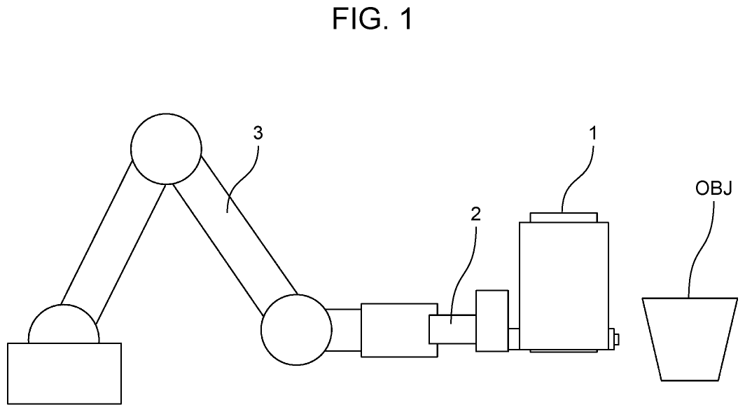

FIG. 1 is a conceptual diagram illustrating robot arm 3 including end effector 2. Robot arm 3 typically includes an articulated arm. End effector 2 is attached to a distal end of the arm. In the present exemplary embodiment, end effector 2 is, for example, a robot hand having two fingers.

Gripping mechanism 1 according to the present exemplary embodiment is attached to a distal end of end effector 2. Gripping mechanism 1 grips gripping target object OBJ such as tableware, for example. However, gripping target object OBJ is not limited to tableware.

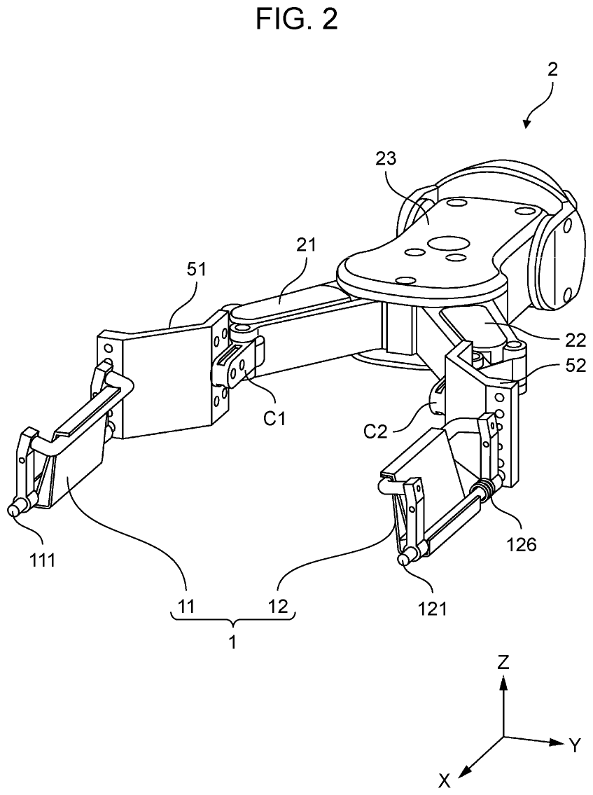

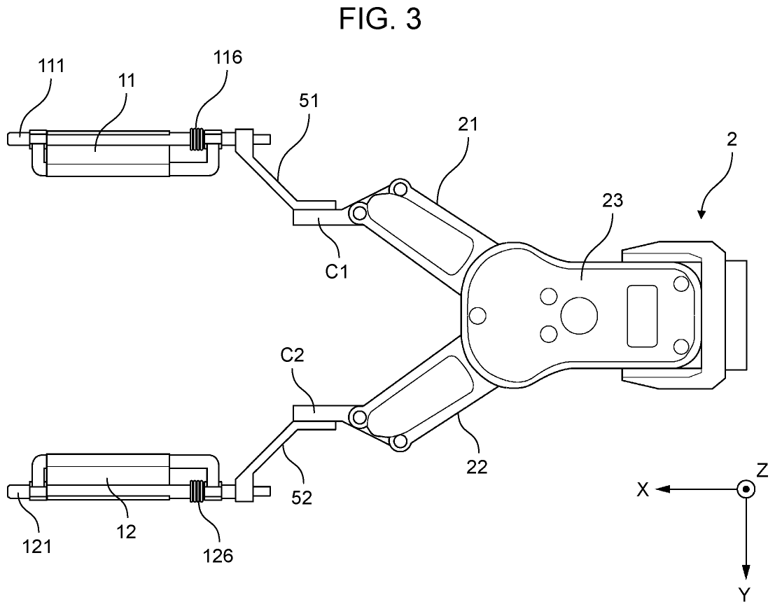

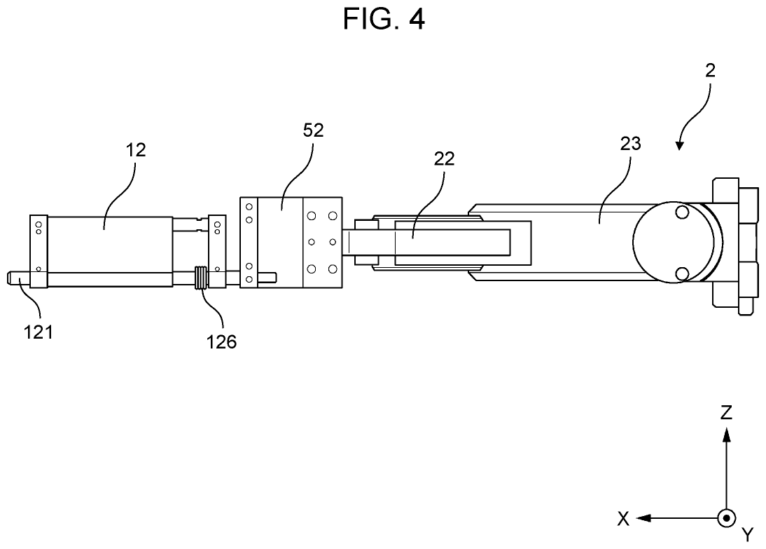

FIG. 2 is a perspective view of end effector 2. FIG. 3 is a top view illustrating end effector 2. FIG. 4 is a side view illustrating end effector 2. End effector 2 to which gripping mechanism 1 is attached at the tip will be described with reference to FIGS. 2 to 4.

For the sake of convenience in description, coordinate axes are introduced. The illustrated coordinate axes are coordinate axes in an orthogonal coordinate system having an X-axis, a Y-axis, and a Z-axis orthogonal to each other. End effector 2 includes base 23, first finger 21, and second finger 22. First finger 21 and second finger 22 are attached to base 23 to be rotatable about an axis parallel to the illustrated Z-axis.

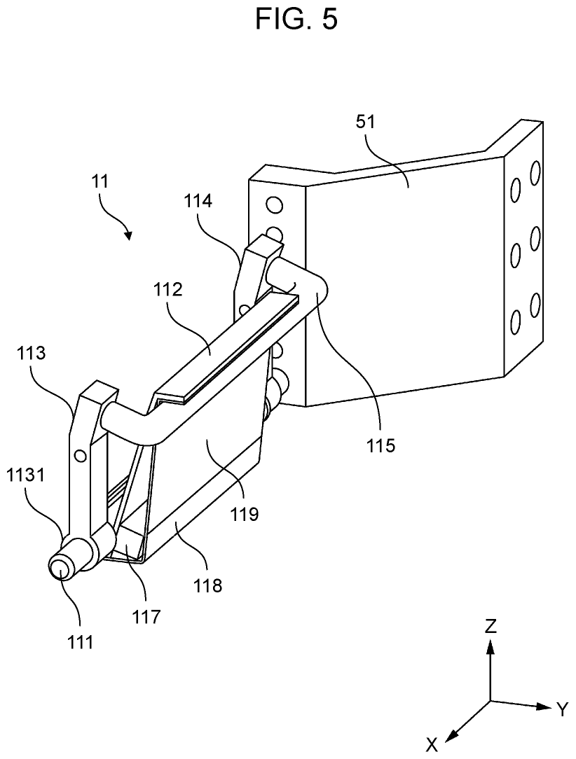

Gripping mechanism 1 includes first gripping part 11 and second gripping part 12. First gripping part 11 and second gripping part 12 face each other. That is, gripping mechanism 1 includes a pair of gripping parts (for example, first gripping part 11 and second gripping part 12) facing each other. First gripping part 11 and second gripping part 12 include rotation shafts 111 and 121, respectively. Rotation shaft 111 extends in a distal end direction of first finger 21. Rotation shaft 121 extends in a distal end direction of second finger 22. In the illustrated example, rotation shaft 111 and rotation shaft 121 extend in an X-axis direction. First gripping part 11 is rotatable about rotation shaft 111. Second gripping part 12 is rotatable about rotation shaft 121. First gripping part 11 and second gripping part 12 face each other in a direction intersecting a direction in which rotation shaft 111 and rotation shaft 121 extend. In the illustrated example, first gripping part 11 and second gripping part 12 face each other in a Y-axis direction which is a direction orthogonal to the X-axis direction which is the direction in which rotation shafts 111 and 121 extend. Note that, torsion spring 116 and torsion spring 126 illustrated in FIGS. 2 to 4 will be described later with reference to FIGS. 5 to 7.

Connection member 51 is disposed between first gripping part 11 and first finger 21. Connection member 51 connects first gripping part 11 and first finger 21. Connection member 52 is disposed between second gripping part 12 and second finger 22. Connection member 52 connects second gripping part 12 and second finger 22. Connection member 51 and connection member 52 are each formed in a bent plate shape having three sides as viewed from a Z-axis direction (see FIG. 3). However, shapes of connection member 51 and connection member 52 are not limited thereto.

First gripping part 11 is connected to one end of connection member 51. More specifically, rotation shaft 111 included in first gripping part 11 is inserted into and fixed to a hole provided at one end of connection member 51. Second gripping part 12 is connected to one end of connection member 52. More specifically, rotation shaft 121 included in second gripping part 12 is inserted into and fixed to a hole provided at one end of connection member 52.

The other end of connection member 51 is fixed to connecting portion C1 protruding from first finger 21. The other end of connection member 52 is fixed to connecting portion C2 protruding from second finger 22. Connecting portion C1 is rotatably attached to two fulcrums (see FIG. 3) of first finger 21 along an axis parallel to the Z-axis in the drawing. Connecting portion C2 is rotatably attached to two fulcrums (see FIG. 3) of second finger 22 along an axis parallel to the Z-axis in the drawing. Thus, even though first finger 21 and second finger 22 are opened and closed, connecting portion C1 and connecting portion C2 maintain a state of being parallel to each other.

Note that, in end effector 2, connection member 51 and connection member 52 may not be provided. In this case, first gripping part 11 and second gripping part 12 may be directly fixed to first finger 21 and second finger 22, respectively.

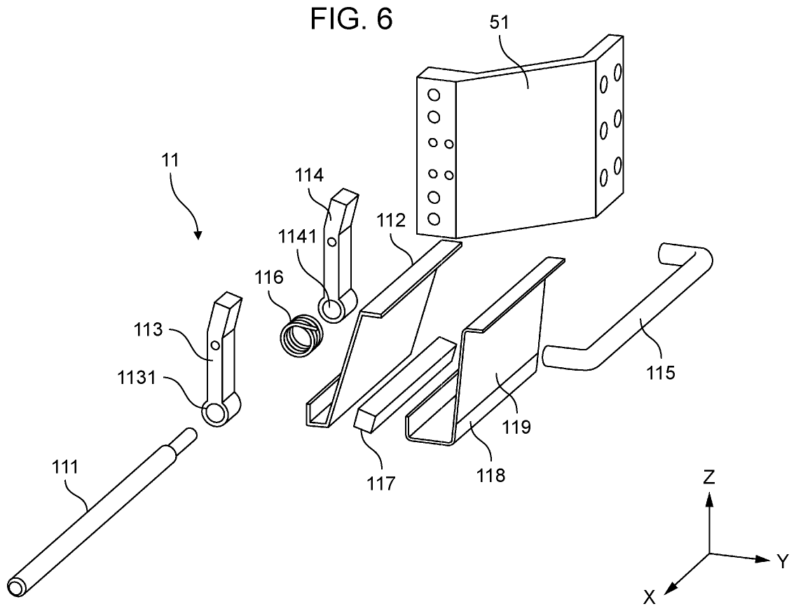

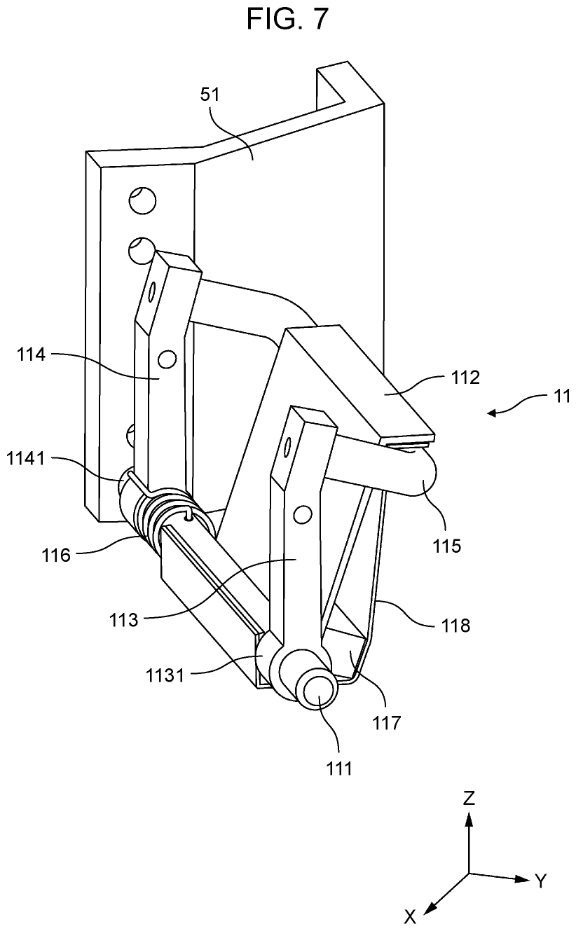

FIG. 5 is a perspective view illustrating first gripping part 11 connected to connection member 51. FIG. 6 is an exploded perspective view of connection member 51 and first gripping part 11. FIG. 7 is a perspective view illustrating first gripping part 11 connected to connection member 51. A structure of first gripping part 11 will be described with reference to FIGS. 5 to 7. Note that, since a structure of second gripping part 12 is similar to the structure of first gripping part 11 except that first gripping part 11 and second gripping part 12 face each other, the description of the structure of first gripping part 11 is similarly applicable, and detailed description is omitted.

First gripping part 11 includes rotation shaft 111, first frame 112, second frame 113 as an example of a frame, third frame 114 as an example of a frame, a rigid stopper 115, and torsion spring 116.

First frame 112 has a generally bent planar shape. One end of first frame 112 is bent in a substantially U shape to wrap rotation shaft 111 along the X-axis direction. The other end of first frame 112 is bent in a generally L shape to ride on rigid stopper 115 to be described later along the X direction. That is, first frame 112 is connected to rigid stopper 115 and rotation shaft 111.

Second frame 113 and third frame 114 have a bent rod shape. Second frame 113 includes perforated ring 1131. Third frame 114 includes perforated ring 1141. Perforated ring 1131 and perforated ring 1141 are provided to correspond to one ends of second frame 113 and third frame 114, respectively. Rotation shaft 111 penetrate through perforated ring 1131 and perforated ring 1141.

Rotation shaft 111 also penetrates through torsion spring 116. As illustrated in FIG. 6, torsion spring 116 may be disposed between third frame 114 and connection member 51. Torsion spring 116 may be disposed between second frame 113 and third frame 114 as depicted in FIGS. 3 and 7.

One end of torsion spring 116 is fixed to rotation shaft 111, and the other end of torsion spring 116 is fixed to third frame 114. Thus, although first gripping part 11 that receives an external force rotates about rotation shaft 111, when the external force disappears, first gripping part 11 returns to an original position by a biasing force of torsion spring 116 having one end fixed to rotation shaft 111.

Rigid stopper 115 has a generally U shape. One end of rigid stopper 115 is inserted into an end of second frame 113 opposite to perforated ring 1131 (see FIG. 5 or 7). The other end of rigid stopper 115 is inserted into an end of third frame 114 opposite to perforated ring 1141 (see FIG. 5 or 7). As a result, a central portion of rigid stopper 115 forms a projection at a first end of first gripping part 11. As illustrated in FIG. 7, rigid stopper 115 is provided between second frame 113 and third frame 114. In addition, first frame 112, second frame 113, third frame 114, and rigid stopper 115 are rotatable about rotation shaft 111. In the present exemplary embodiment, the first end of first gripping part 11 is an end on a side toward the Z-axis direction in the drawing. A second end of first gripping part 11 is an end on a side toward a direction opposite to the Z-axis direction in the drawing.

Cushion 117 is provided at first gripping part 11. Cushion 117 is provided on a side of rotation shaft 111 facing second gripping part 12 which is the other facing gripping part. In the present exemplary embodiment, cushion 117 is provided on the Y-axis direction side of rotation shaft 111. In addition, as illustrated in FIG. 5, cushion 117 is provided between first frame 112 and elastic sheet 118. Cushion 117 is provided at first gripping part 11, and thus, gripping mechanism 1 can fit and receive the shape of the gripping target object (for example, tableware). Accordingly, the gripping target object can be stably gripped. In addition, cushion 117 is provided at the above-described position of first gripping part 11 (that is, the position of rotation shaft 111 on the side toward second gripping part 12 which is the other facing gripping part), the external force received by cushion 117 from the gripping target object does not cause the rotation of first gripping part 11 about rotation shaft 111. Thus, when the gripping target object (in particular, a cylindrical gripping target object such as a cup) is gripped, a relative position of first gripping part 11 with respect to the gripping target object does not deviate in a rotation direction of first gripping part 11. Accordingly, gripping mechanism 1 can more stably grip the gripping target object.

Note that, in the present exemplary embodiment, cushion 117 is disposed between first frame 112 and elastic sheet 118 to be described later. As a result, cushion 117 can press elastic sheet 118 to be described later against the gripping target object. Then, since an installation area of elastic sheet 118 and the gripping target object is increased, the gripping target object can be gripped with a wider surface. As a result, stability of gripping by first gripping part 11 increases.

Elastic sheet 118 is provided on a surface of first gripping part 11 on the side toward second gripping part 12 which is the other facing gripping part. Elastic sheet 118 is made of a deformable member such as silicone. In the present exemplary embodiment, elastic sheet 118 is fixed to an end of first frame 112 on rotation shaft 111 side and an end on rigid stopper 115 side. In addition, as described above, cushion 117 is provided at an end on rotation shaft 111 side between elastic sheet 118 and first frame 112, and a clearance space is generated on rigid stopper 115 side. This clearance space becomes a deformation space of elastic sheet 118, absorbs a difference in a side surface shape of the gripping target object such as a flat dish or a deep dish, and fits the shape of the gripping target object. That is, in elastic sheet 118, rigid stopper 115 side is more easily deformed than rotation shaft 111 side depending on the presence or absence of cushion 117.

With the above configuration, since gripping mechanism 1 can grip the gripping target object on the surface, the gripping target object can be stably gripped. In addition, since elastic sheet 118 is in close contact with the gripping target object, the gripping target object can be gripped more stably.

Preferably, friction on a first end side close to the first end of first gripping part 11 in elastic sheet 118 is smaller than friction on the second end side close to the second end of first gripping part 11. As a result, the gripping target object in contact with elastic sheet 118 easily moves toward rigid stopper 115. In addition, the second end side of first gripping part 11 in elastic sheet 118 is less slippery than the first end side. As a result, the gripping target object can be held on the second end side that is less slippery. Note that, in the present exemplary embodiment, low friction sheet 119 is attached to the first end side of first gripping part 11 in elastic sheet 118, that is, the side close to rigid stopper 115. The friction of low friction sheet 119 is smaller than the friction of elastic sheet 118. However, a method for setting a difference to be caused in frictional force between the first end side and the second end side of first gripping part 11 in elastic sheet 118 is not limited thereto. For example, elastic sheet 118 itself may be formed by a low friction sheet. Then, a sheet having a large frictional force may be attached to the second end side of first gripping part 11 in low friction elastic sheet 118, or anti-slip processing may be performed.

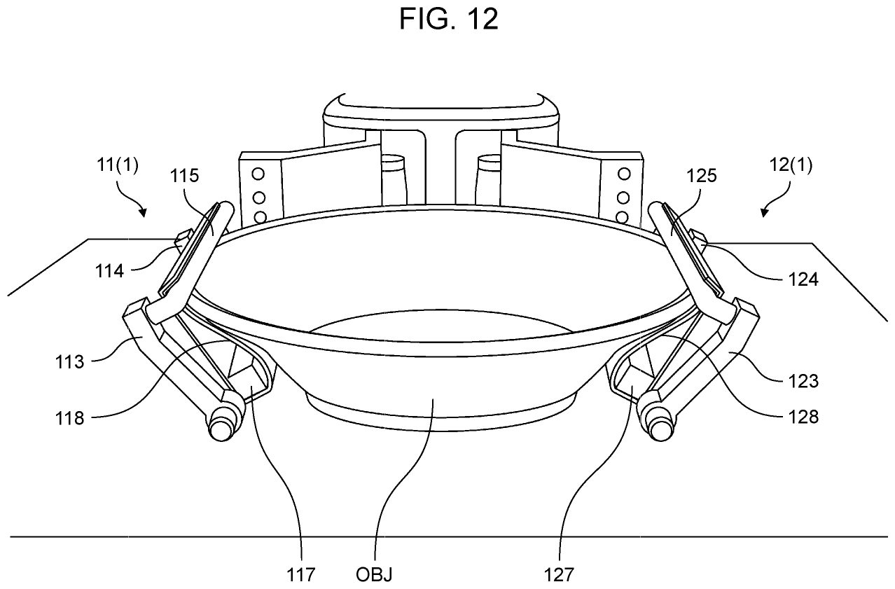

Note that, referring also to FIGS. 7 and 12, second frame 113 has a first end side connected to rigid stopper 115 and a second end side connected to rotation shaft 111. The first end side of first gripping part 11 in second frame 113 and third frame 114 is bent toward the other facing gripping part (that is, second gripping part 12). In the present exemplary embodiment, second frame 113 and third frame 114 are bent, for example, in an inverted V shape. As a result, as compared with a case where second frame 113 and third frame 114 are linearly formed in an I shape, a projection (for example, rigid stopper 115) falls down in a direction of the gripping target object and has a positional relationship parallel to the gripping target object. Thus, in a case where the gripping target object slides in an upward direction (Z-axis direction in the drawing) when being gripped by gripping mechanism 1, the gripping target object is prevented from coming off the projection (for example, rigid stopper 115).

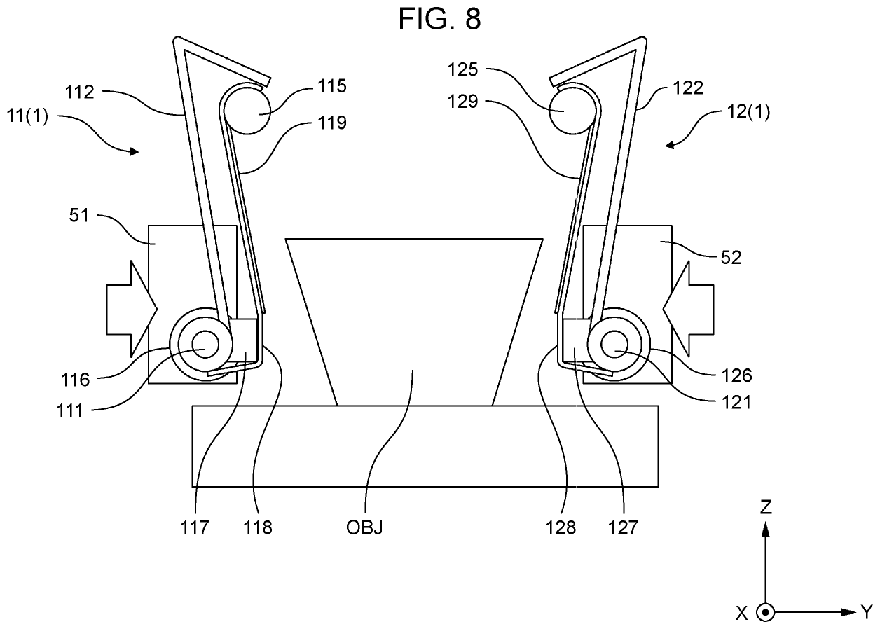

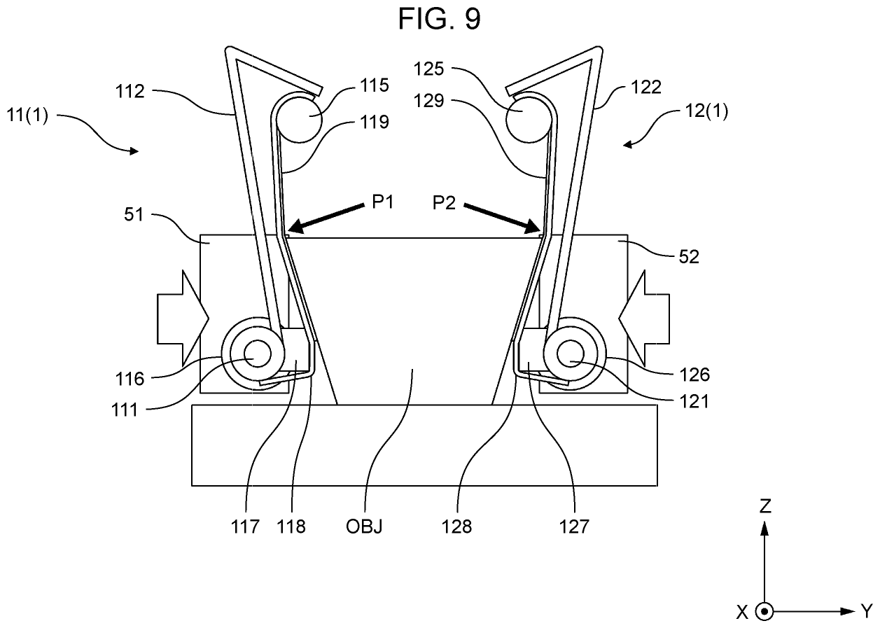

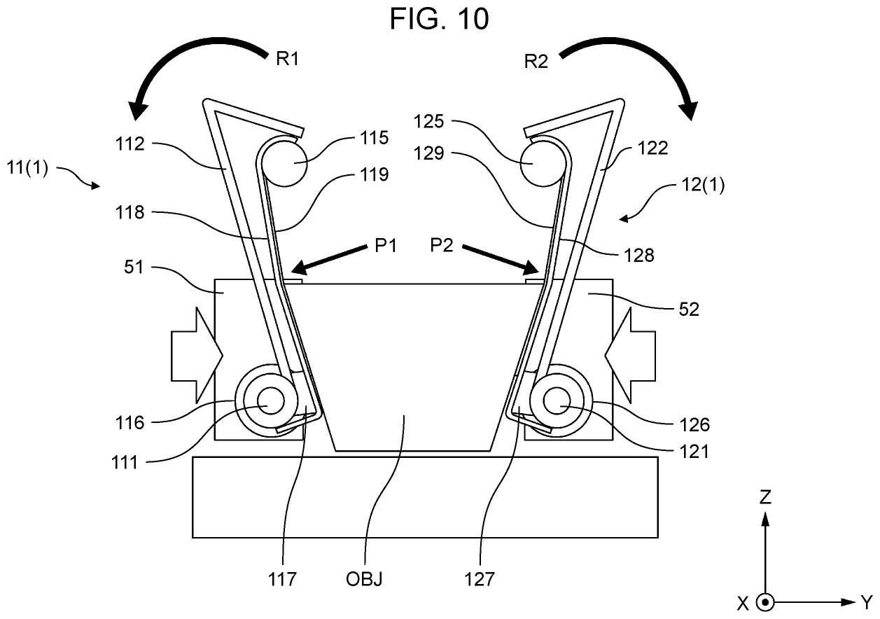

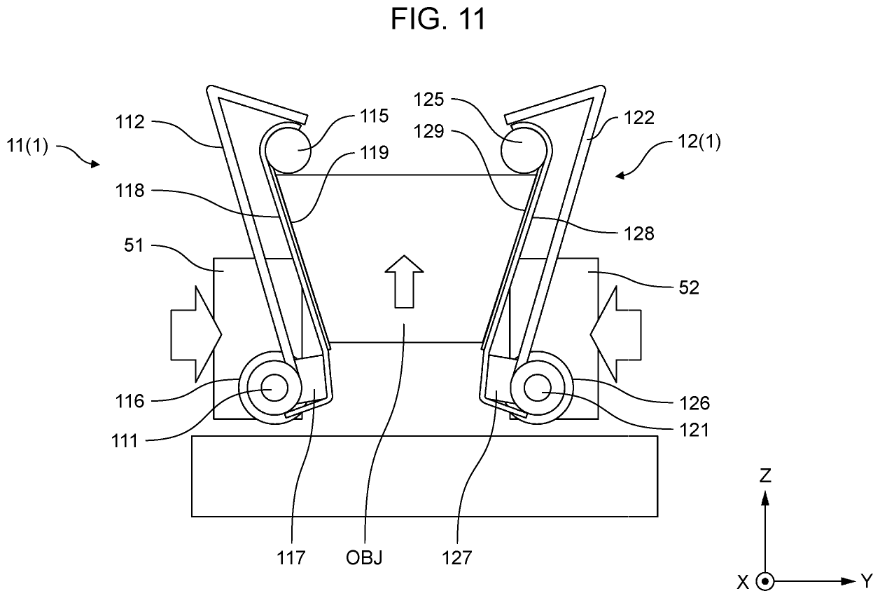

FIG. 8 is a conceptual diagram illustrating a first state when gripping mechanism 1 grips gripping target object OBJ. FIG. 9 is a conceptual diagram illustrating a second state when gripping mechanism 1 grips gripping target object OBJ. FIG. 10 is a conceptual diagram illustrating a third state when gripping mechanism 1 grips gripping target object OBJ. FIG. 11 is a conceptual diagram illustrating a fourth state when gripping mechanism 1 grips gripping target object OBJ. The gripping of gripping target object OBJ by gripping mechanism 1 will be described with reference to FIGS. 8 to 11.

Here, second gripping part 12 included in gripping mechanism 1 has a structure similar to first gripping part 11 except that first gripping part 11 and second gripping part 12 face each other. Reference marks for components of second gripping part 12 similar to the components of first gripping part 11 denote rotation shaft 121, first frame 122, second frame 123, third frame 124, rigid stopper 125, torsion spring 126, cushion 127, elastic sheet 128, and low friction sheet 129, respectively. As illustrated in FIG. 8, cushion 117 of first gripping part 11 and cushion 127 of second gripping part 12 are provided between rotation shaft 111 of first gripping part 11 and rotation shaft 121 of second gripping part 12. In addition, elastic sheet 118 of first gripping part 11 and elastic sheet 128 of second gripping part 12 face each other in the direction (for example, in the Y-axis direction) intersecting the direction (for example, in the X-axis direction) in which rotation shafts 111 and 121 extend.

FIG. 8 illustrates the first state when gripping mechanism 1 grips gripping target object OBJ. Control device 100 to be described later controls end effector 2 to gradually bring first gripping part 11 and second gripping part 12 of gripping mechanism 1 closer to gripping target object OBJ from an outside (that is, outer peripheral side). Note that, in the present exemplary embodiment, gripping target object OBJ is tableware. The tableware has a truncated cone shape with a diameter increasing in the upward direction (Z-axis direction in the drawing), such as a ramen bowl (in other words, a ramen pot). However, as will be described later, gripping mechanism 1 can grip a gripping target object having another shape.

FIG. 9 illustrates the second state when gripping mechanism 1 grips gripping target object OBJ. Control device 100 to be described later controls end effector 2 to press first gripping part 11 and second gripping part 12 of gripping mechanism 1 against the outside of gripping target object OBJ (that is, outer peripheral side). Then, elastic sheet 118 and elastic sheet 128, and low friction sheet 119 and low friction sheet 129 first come into contact with largest diameter portions of gripping target object OBJ (see arrows denoted by reference marks P1 and P2 in the drawing).

Control device 100 to be described later controls end effector 2 to further press first gripping part 11 and second gripping part 12 of gripping mechanism 1 to the outside of gripping target object OBJ (that is, outer peripheral side). Then, elastic sheet 118 and elastic sheet 128, and low friction sheet 119 and low friction sheet 129 follow a side surface shape of gripping target object OBJ while being deformed. Portions of elastic sheet 118 and elastic sheet 128 and portions of low friction sheet 119 and low friction sheet 129 near portions where cushion 117 and cushion 127 are disposed come into contact with the side surface of gripping target object OBJ.

FIG. 10 illustrates the third state when gripping mechanism 1 grips gripping target object OBJ. Control device 100 to be described later controls end effector 2 to further press first gripping part 11 and second gripping part 12 of gripping mechanism 1 to the outside of gripping target object OBJ (that is, outer peripheral side). Then, first gripping part 11 and second gripping part 12 rotate outward about rotation shaft 111 and rotation shaft 121 against biasing forces of torsion spring 116 and torsion spring 126, respectively. In the drawing, rotation shaft 111 and rotation shaft 121 extend in the X-axis direction. The rotation directions of first gripping part 11 and second gripping part 12 are indicated by arrows denoted by reference marks R1 and R2 in the drawing.

Gripping target object OBJ is sandwiched from both sides by cushion 117 and cushion 127, elastic sheet 118 and elastic sheet 128, and low friction sheet 119 and low friction sheet 129. Here, since low friction sheet 119 and low friction sheet 129 have low frictional forces, when first gripping part 11 and second gripping part 12 are further pressed against the outside (that is, outer peripheral side) of gripping target object OBJ, gripping target object OBJ slides along the inclination. Thus, gripping target object OBJ moves in the direction in which rigid stopper 115 and rigid stopper 125 are disposed. In the illustrated example, gripping target object OBJ moves in the Z-axis direction in the drawing. The state after the movement is illustrated in FIG. 11.

FIG. 11 illustrates the fourth state when gripping mechanism 1 grips gripping target object OBJ. An edge of gripping target object OBJ comes into contact with rigid stopper 115 and rigid stopper 125 to block further movement in the Z-axis direction. Thus, gripping target object OBJ is sandwiched and stably gripped by the members disposed on the first end sides of first gripping part 11 and second gripping part 12 and the members disposed on the second end sides of first gripping part 11 and second gripping part 12. The members disposed on the first end sides of first gripping part 11 and second gripping part 12 are rigid stopper 115 and rigid stopper 125. The members disposed on the second end side of first gripping part 11 and second gripping part 12 are cushion 117 and cushion 127, elastic sheet 118 and elastic sheet 128, and low friction sheet 119 and low friction sheet 129.

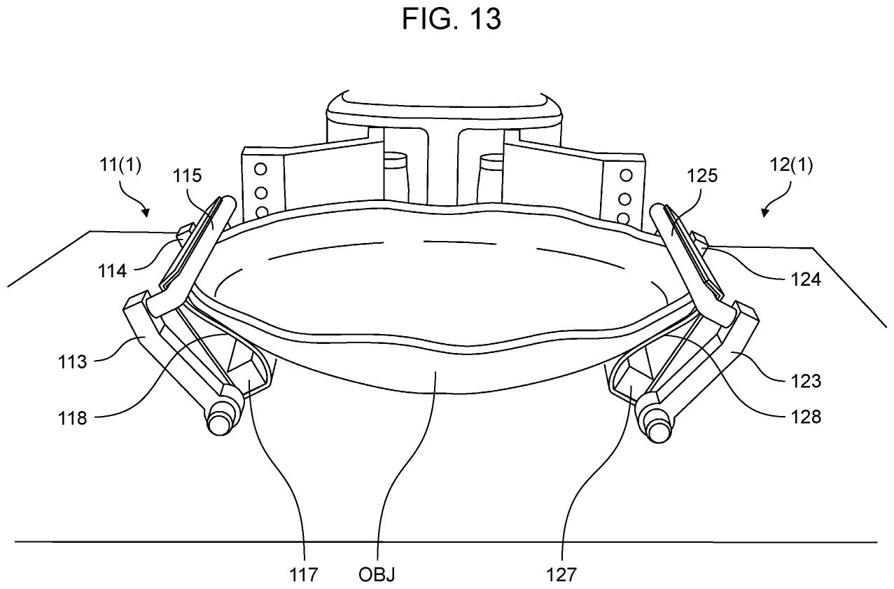

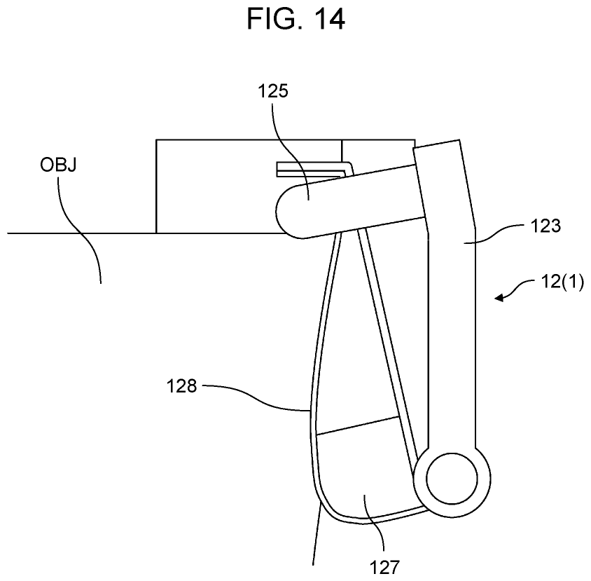

FIG. 12 is a diagram illustrating a gripping example of gripping target object OBJ by gripping mechanism 1. FIG. 13 is a diagram illustrating a gripping example of gripping target object OBJ by gripping mechanism 1. FIG. 14 is a diagram illustrating a gripping example of gripping target object OBJ by gripping mechanism 1.

As illustrated in FIGS. 12 and 13, gripping mechanism 1 according to the present exemplary embodiment can stably grip a plurality of types of gripping target objects OBJ having different heights and different side surface shapes. This is because rigid stopper 115 and rigid stopper 125 disposed on an upper side in the drawing hold gripping target objects OBJ by a line (that is, linearly along the X-axis direction), and portions of elastic sheet 118 and elastic sheet 128 near a lower side in the drawing, and cushion 117 and cushion 127 fit shapes of gripping target objects OBJ and hold gripping target objects OBJ by a surface. In addition, even though side surfaces of gripping target objects OBJ are not linear, since elastic sheet 118 and elastic sheet 128 are deformed along the side surface shapes of gripping target objects OBJ, elastic sheet 118 and elastic sheet 128 are in close contact with gripping target objects OBJ, and gripping target objects OBJ can be stably gripped.

In addition, as illustrated in FIG. 14, gripping mechanism 1 according to the present exemplary embodiment can stably grip a generally cylindrical gripping target object OBJ having no inclination in the side surface. Frictional forces are large in portions of elastic sheet 118 and elastic sheet 128 close to cushion 117 and cushion 127. Thus, cushion 117 and cushion 127 press elastic sheet 118 and elastic sheet 128 against gripping target objects OBJ, and thus, gripping target objects OBJ can be stably gripped by the frictional forces.

In addition, although not illustrated, gripping mechanism 1 according to the present exemplary embodiment can also grip the gripping target object having a truncated cone shape with a diameter decreasing in the upward direction, such as a ramen bowl turned upside down.

In addition, gripping mechanism 1 according to the present exemplary embodiment can grip various gripping target objects, such as pots, flower pots, beer bottles, boxes, fire extinguishers, paper packs, and plastic bottles.

In particular, gripping mechanism 1 according to the present exemplary embodiment can grip a gripping target object having an irregular shape placed on the ground. Such a gripping target object having an irregular shape has been difficult to grip in the related art.

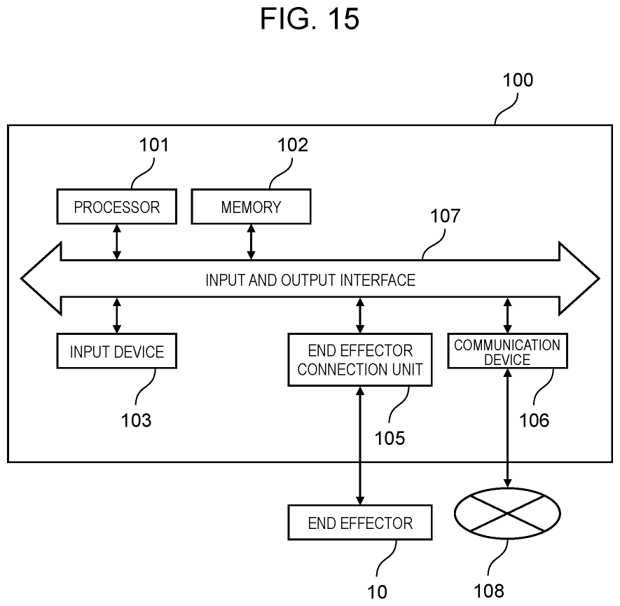

FIG. 15 is a block diagram illustrating a hardware configuration example of control device 100. Control device 100 includes processor 101, memory 102, input device 103, end effector connection unit 105, communication device 106, and input and output interface 107.

Processor 101 is constructed by using, for example, a central processing unit (CPU), a micro processing unit (MPU), a graphical processing unit (GPU), a digital signal processor (DSP), or a field-programmable gate array (FPGA). Processor 101 performs various kinds of processing and control in control device 100 in cooperation with memory 102. For example, processor 101 acquires various kinds of feedback information from end effector 2 via end effector connection unit 105, generates a control signal for controlling an operation of end effector 2, and transmits the control signal to end effector 2.

Memory 102 includes, for example, a random access memory (RAM) as a work memory used when processing of processor 101 is executed, and a read only memory (ROM) that stores a program that defines the processing of processor 101. Data generated or acquired by processor 101 is temporarily stored in the RAM. The program that defines the processing of processor 101 is written to the ROM. Memory 102 may store operation content information that is information defining contents of an operation to be performed by end effector 2. The operation content information includes, for example, a program for end effector 2 to perform a certain operation.

Input device 103 is a device for a user to input information. Specifically, input device 103 may be a keyboard, a mouse, a teaching pendant, or the like. Input device 103 may be a device other than a keyboard, a mouse, and a teaching pendant.

End effector connection unit 105 is constructed by using an input and output circuit having a function of connecting end effector 2 and control device 100. For example, information is transmitted between processor 101 and the like and end effector 2 via end effector connection unit 105.

Communication device 106 has a general function for performing information communication with an external device via communication network 108 such as the Internet.

Input and output interface 107 is interposed between memory 102, input device 103, the end effector connection unit 105, and communication device 106, and processor 101, and has a function of inputting and outputting data therebetween.

Note that, control device 100 may further include components other than the components described above.

As described above, gripping mechanism 1 according to the present exemplary embodiment includes the pair of gripping parts (specifically, first gripping part 11 and second gripping part 12) facing each other. The pair of first gripping parts 11 and second gripping part 12 include the projections (specifically, rigid stoppers 115 and 125) at the first ends of first gripping part 11 and second gripping part 12. The pair of first gripping parts 11 and second gripping part 12 is rotatable about rotation shafts 111 and 121 provided on the second end side opposite to the first ends of first gripping part 11 and second gripping part 12. The pair of first gripping parts 11 and second gripping part 12 faces each other in the direction intersecting the direction in which rotation shafts 111 and 121 extend. As a result, gripping mechanism 1 can slide first gripping part 11 and second gripping part 12 with respect to gripping target object OBJ to sandwich gripping target object OBJ between the projections (rigid stoppers 115 and 125) and first gripping part 11 and second gripping part 12. Thus, gripping mechanism 1 can stably grip gripping target object OBJ.

In addition, the pair of first gripping parts 11 and second gripping part 12 further include corresponding cushions 117 and 127. Cushions 117 and 127 are provided in a direction parallel to corresponding rotation shafts 111 and 121 and on the side toward other facing second gripping part 12 and first gripping part 11. As a result, since gripping mechanism 1 can softly receive gripping target object OBJ, gripping target object OBJ can be stably gripped. In addition, the external force received by cushions 117 and 127 from gripping target object OBJ does not cause the rotation of first gripping part 11 and second gripping part 12 about the rotation shafts 111 and 121. Thus, when the gripping is performed, the relative positions of first gripping part 11 and second gripping part 12 with respect to gripping target object OBJ do not deviate in the rotation direction. Accordingly, gripping mechanism 1 can more stably grip gripping target object OBJ.

In addition, the pair of first gripping parts 11 and second gripping part 12 further includes corresponding elastic sheets 118 and 128 on the surface on the side toward other facing second gripping part 12 and first gripping part 11. As a result, since elastic sheets 118 and 128 are in close contact with gripping target object OBJ, gripping mechanism 1 can more stably grip gripping target object OBJ.

In addition, in the pair of first gripping parts 11 and second gripping part 12, the friction of elastic sheets 118 and 128 is smaller at the first end side of first gripping part 11 and second gripping part 12 than at the second end side opposite to the first end side. As a result, gripping target object OBJ can easily move toward the projections (specifically, rigid stoppers 115 and 125), and gripping mechanism 1 can more stably grip gripping target object OBJ.

In addition, the projection (for example, rigid stopper 115) is provided on second frame 113 and third frame 114 including perforated rings 1131 and 1141 through which rotation shaft 111 penetrates. The first end side of first gripping part 11 in second frame 113 and third frame 114 is bent toward other facing second gripping part 12 side. As a result, the projection (for example, rigid stopper 115) falls down in the direction of the gripping target object. Thus, in a case where the gripping target object slides upward direction (Z-axis direction), the gripping target object is prevented from coming off the projection (for example, rigid stopper 115).

In addition, end effector 2 includes gripping mechanism 1 described above. As a result, it is possible to provide end effector 2 capable of stably gripping target object OBJ.

Various exemplary embodiments are described with reference to the drawings, but it is a matter of course that the present disclosure is not limited to such examples. For those skilled in the art, it is obvious that various modification examples, rectification examples, substitution examples, addition examples, deletion examples, and equivalent examples could be conceived within the scope of claims, and thus it is obviously understood that those examples belong to the technical scope of the present disclosure. In addition, the elements included in the various exemplary embodiments described above may be combined in any way, within the scope not departing from the gist of the present invention.

The present disclosure is useful as a gripping mechanism and an end effector capable of stably gripping a gripping target object.

What is claimed is:

1. A gripping mechanism comprising a pair of gripping parts that includes a first gripping part and a second gripping part facing each other,
wherein
each of the first gripping part and the second gripping part includes
a first end,
a second end opposite to the first end,
a projection provided at the first end, and
a rotation shaft provided at the second end,
the projection is rotatable about the rotation shaft, and
the first gripping part and the second gripping part face each other in a direction intersecting a direction in which the rotation shafts extend.

2. The gripping mechanism according to claim 1, wherein
each of the first gripping part and the second gripping part further includes a cushion, and
the cushion of the first gripping part and the cushion of the second gripping part are provided between the rotation shaft of the first gripping part and the rotation shaft of the second gripping part.

3. The gripping mechanism according to claim 2, wherein
each of the first gripping part and the second gripping part further includes an elastic sheet, and
the elastic sheet of the first gripping part and the elastic sheet of the second gripping part face each other in the direction intersecting the direction in which the rotation shafts extend.

4. The gripping mechanism according to claim 3, wherein
the elastic sheet has a first end side close to the first end and a second end side close to the second end, and
friction of the first end side of the elastic sheet is smaller than friction of the second end side of the elastic sheet.

5. The gripping mechanism according to claim 3, wherein
the elastic sheet has a first end side close to the first end, and a second end side close to the second end, and
the elastic sheet includes a friction sheet having friction smaller than friction of the elastic sheet, the friction sheet being attached to the first end side of the elastic sheet.

6. The gripping mechanism according to claim 3, wherein
each of the first gripping part and the second gripping part further includes a first frame connected to the projection and the rotation shaft, and
the cushion is provided between the first frame and the elastic sheet.

7. The gripping mechanism according to claim 1, wherein
each of the first gripping part and the second gripping part further includes a second frame connected to the projection, the second frame having a perforated ring through which the rotation shaft penetrates,
the second frame has a first end side connected to the projection and a second end side connected to the rotation shaft, and
the first end side of the second frame of the first gripping part is bent toward the second gripping part.

8. The gripping mechanism according to claim 7, wherein
each of the first gripping part and the second gripping part further includes a third frame connected to the projection, the third frame having a perforated ring through which the rotation shaft penetrates,
the third frame has a first end side connected to the projection and a second end side connected to the rotation shaft,
the first end side of the third frame of the first gripping part is bent toward the second gripping part, and
the projection is provided between the second frame and the third frame.

9. An end effector comprising the gripping mechanism according to claim 1.

10. The end effector according to claim 9, further comprising:
a first finger connected to the first gripping part;
a second finger connected to the second gripping part; and
a base connected to the first finger and the second finger,
wherein each of the first finger and the second finger is rotatable about the base with, as a center, an axis orthogonal to the direction in which the rotation shafts extend.

11. The gripping mechanism according to claim 1, wherein a relative position of the rotation shaft of each of the first gripping part and the second gripping part changes when a relative position between the first gripping part and the second gripping part changes.
